(19) United States
(12) Patent Application Publication
(10) Pub. No.: US 2010/0310330 A1
(43) Pub. Date: Dec. 9, 2010

(54) Speed-change device for drill machine

(76) Inventor: Hui-Lan Liao, Dali City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/727,897

(22) Filed: Mar. 19, 2010

(30) Foreign Application Priority Data
Jun. 3, 2009 (CN) 200920158002.8

(51) Int. Cl. B23B 47/16; B23Q 5/12

(52) U.S. Cl. 408/128

(57) ABSTRACT

A speed-change device for a drill machine, wherein the drill machine includes a drive motor having a spindle, a cutter connective shaft and a shell member, the device comprises an active disc unit installed to the spindle and including a first wedged disc and a second wedged disc paired and coupled to the first wedged disc; a driven disc unit installed to the cutter connective shaft and including a first wedged disc and a second wedged disc paired and coupled to the first wedged disc; a belt wound around the active disc unit and the driven disc unit, with the active disc unit driving the driven disc unit to operate via the belt; and an driven operating unit installed to the shell member and including a driven element and a pressing element which is fixed to the shell member and includes a fulcrum, an operating portion and an adjusting portion.

### BACKGROUND OF THE INVENTION

1. Field of the Invention

The present invention relates to a speed-change device for a drill machine, and more particularly to a stepless variable speed-change device.

2. Description of the Related Art

Referring to China patent No. 96208769.6, a speed-change device for a drill machine, the device includes an active wheel, a driven wheel and a belt. A clutch adjustment unit is coaxially installed to the active wheel. Users operate the clutch adjustment unit to control wedged discs of the active wheel to attach to/detach from each other and further drive the belt to move along the active wheel and the driven wheel.

However, the wedged discs have smooth wedged surfaces which face to each other and are adapted to press the belt in operation. While the wedged discs are operated to attach to/detach from each other, it can only rely on the friction between the wedged discs and the clutch adjustment unit. Hence, torque adapted to force the wedged discs to attach to/detach from each other would be insufficient. During a long-term usage, the belt would be easy to fray or ravel and affect the operation of the motor. Further, the belt which is wound between the wedged discs with smooth surfaces would be easy to slip during rotation.

User operates a rotary element of the coaxial clutch adjustment unit related to the active wheel to control the wedged discs of the active wheel to attach to/detach from each other. However, number of rotations of the rotary element being adjusted is decided by the distance between the wedged discs and it does not provide any time-saving or effort-saving component for the clutch adjustment unit.

### SUMMARY OF THE INVENTION

Accordingly, the object is achieved by providing a stepless variable speed-change device for a drill machine, the device comprises an active disc unit installed to a drive motor of the drill machine and including first and second wedged discs paired to each other, a driven disc unit installed to a cutter connective shaft of the drill machine and including first and second wedged discs paired to each other, a belt, an adjustment unit installed to a lateral wall of the shell member of the drill machine and a driven operating unit installed to the shell member of the drill machine. The first and second wedged discs of active disc unit are operated to move with respect to each other along a spindle as to control number of rotations of the belt around the wedged discs of the active and driven disc units via a lever-type adjustment. The adjustment unit is provided to the speed-change device in position for an ergonomic operation. The first and second wedged discs of the active and driven disc units respectively form with convex ribs and concave portions so that the related first and second wedged discs can be coupled to each other with larger contact area for stepless variably speed-change.

The active disc unit drives the driven disc unit via the belt, and while adjusting position of the belt, a height position of a portion of the belt wound on the active disc unit is equal to that of a portion of the belt wound on the driven disc unit. And the belt would not slip between the active and driven disc units in operation and is not easy to fray or ravel.

Other advantages and features of the present invention will become apparent from the following descriptions referring to the drawings.

### BRIEF DESCRIPTION OF THE DRAWINGS

The present invention will be described through detailed illustration of the preferred embodiment referring to the drawings.

FIG. 1 is a perspective view of a speed-change device for a drill machine according to the preferred embodiment of the present invention.

FIG. 2 is an exploded view of the device as shown in FIG. 1.

FIG. 3 is another exploded view of the device as shown in FIG. 1.

FIG. 4 is a cross-sectional view taken along 4-4 in FIG. 3.

FIG. 5 is a cross-sectional view taken along 5-5 in FIG. 1.

FIG. 6 is a cross-sectional view taken along 6-6 in FIG. 1.

FIG. 7 is a cross-sectional view similar to FIG. 5, illustrating operation of the adjustment unit.

FIG. 8 is a cross-sectional view similar to FIG. 4, illustrating adjustment of the belt.

### DETAILED DESCRIPTION OF THE PREFERRED EMBODIMENT

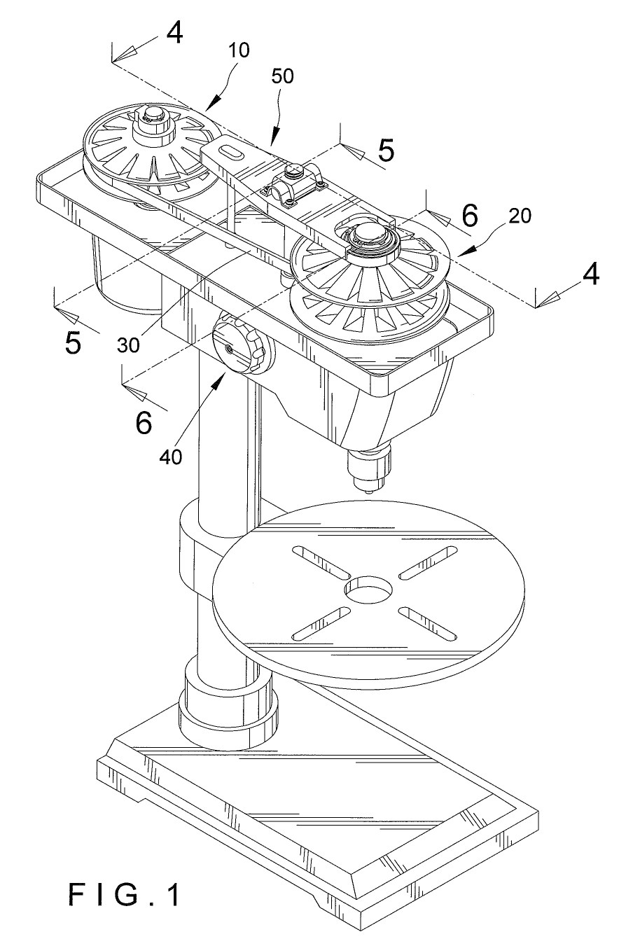

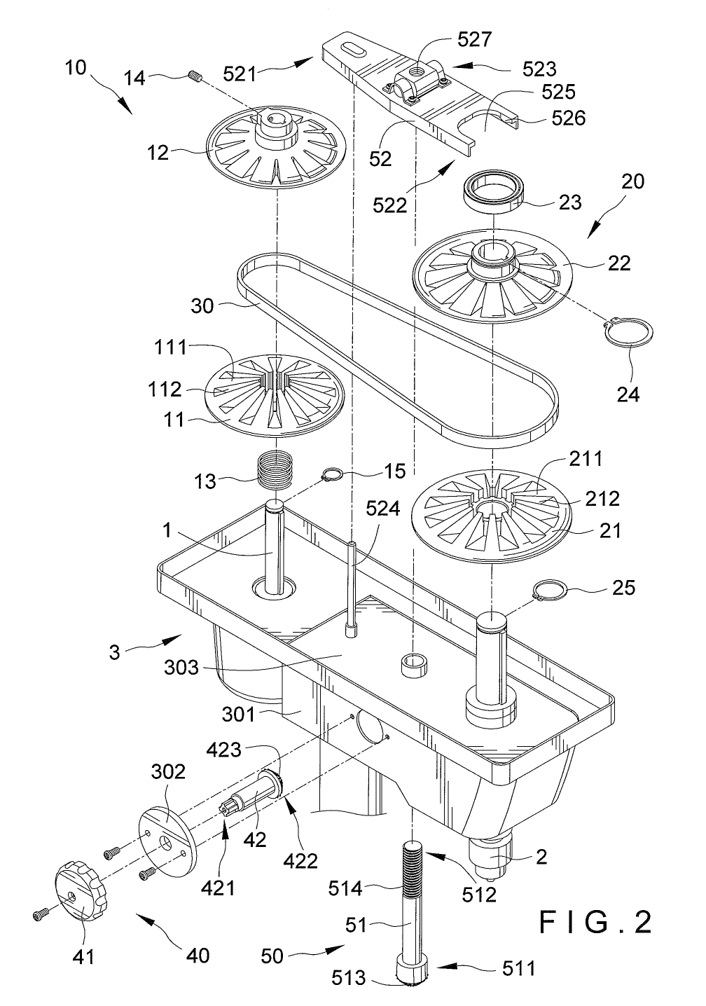

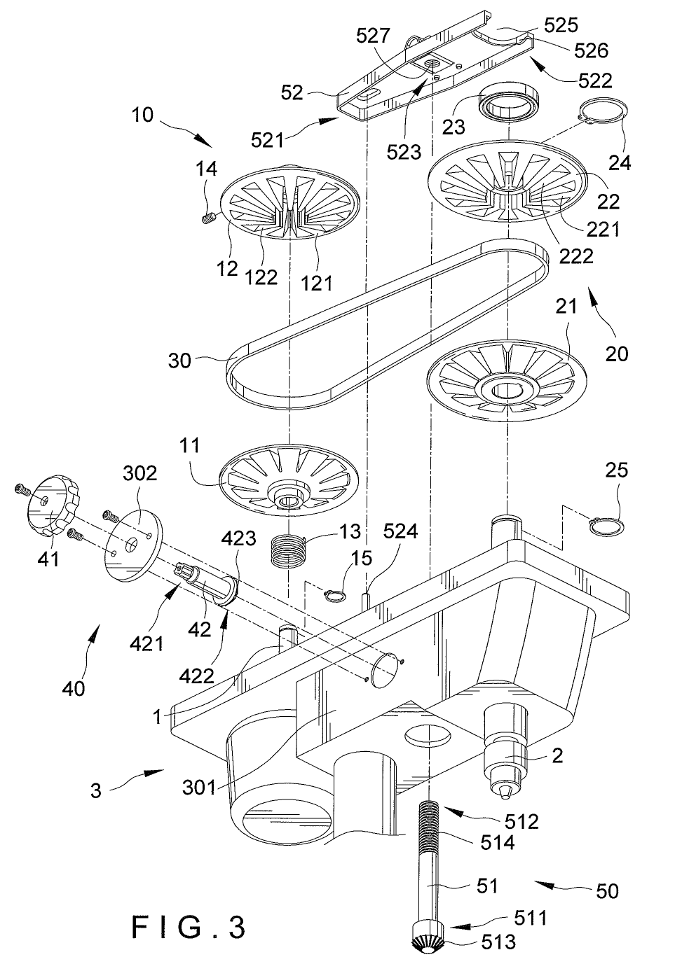

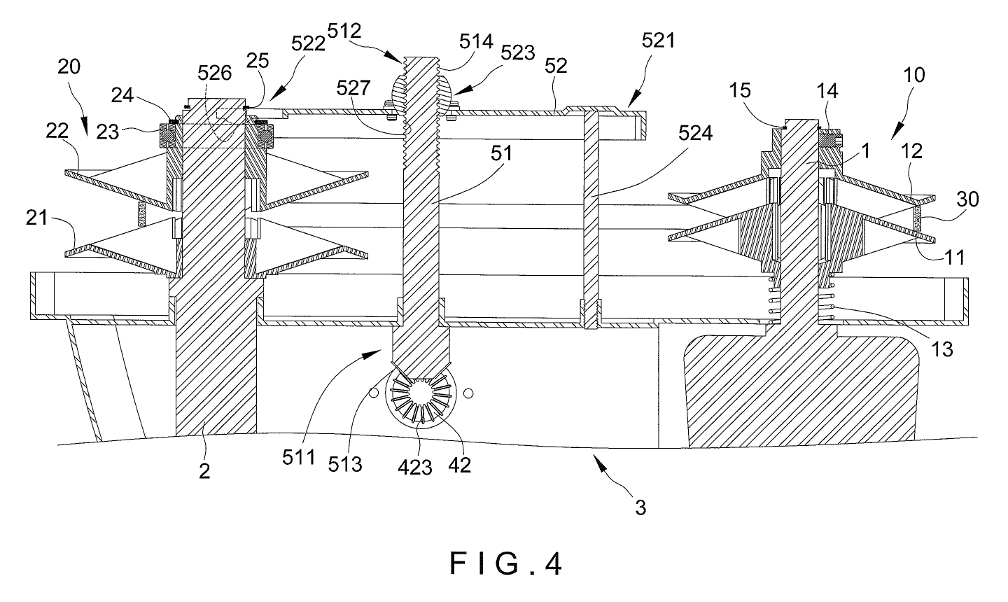

With reference to FIGS. 1 through 4, they show that a speed-change device for a drill machine, the device includes an active disc unit 10 installed to a drive motor of the drill machine, a driven disc unit 20 installed to a cutter connective shaft 2 of the drill machine, a belt 30, an adjustment unit 40 installed to a lateral wall 301 of the shell member 3 of the drill machine and a driven operating unit 50 installed to the shell member 3 of the drill machine.

The active disc unit 10 includes a first wedged disc 11, a second wedged disc 12 paired with the first wedged disc 11 and an elastic element 13 provided between the first wedged disc 11 and a shell member 3 of the drill machine. A side of the first wedged disc 11 which faces to a side of the second wedged disc 12 includes numbers of convex ribs 111 and numbers of concave portions 112, and numbers of convex ribs 121 and numbers of concave portions 122 are formed on the side of the second wedged disc 12 and correspond to the numbers of concave portions 112 and numbers of convex ribs 111 in a convex-concave mating manner for stepless variably speed-changing. It provides a large torque to the first and second wedged discs 11 and 12 for a precise adjustment of positions on a spindle 1. The second wedged disc 12 is fixed to a distal of the spindle 1 of the drive motor via a bolt 14 and a C-clip 15 hooks on the distal of the spindle 1 for preventing the second wedged disc 12 detaching from the distal of the spindle 1. The first wedged disc 11 is able to slide along and with respect to the spindle 1.

The driven disc unit 20 includes a first wedged disc 21, a second wedged disc 22 paired with the first wedged disc 21 and a bearing 23. A side of the first wedged disc 21 which faces to a side of the second wedged disc 22 includes numbers of convex ribs 211 and numbers of concave portions 212, and numbers of convex ribs 221 and numbers of concave portions 222 are formed on the side of the second wedged disc 22 and correspond to the numbers of concave portions 212 and numbers of convex ribs 211 in a convex-concave mating manner for stepless variably speed-changing. The first and second wedged discs 21 and 22 are mounted on the cutter connective shaft 2. The bearing 23 is provided at a side of the second wedged disc 22 opposite to the first wedged disc 21. A C-clip 24 hooks on a distal of the second wedged disc 22 for preventing the bearing 23 detaching from the second wedged disc 22. A C-clip 25 hooks on a distal of the cutter connective shaft 2 for preventing the second wedged disc 22 detaching from the cutter connective shaft 2.

The belt 30 is provided between the active disc unit 10 and the driven disc unit 20 so that the active disc unit 10 drives the driven disc unit 20 to be operated.

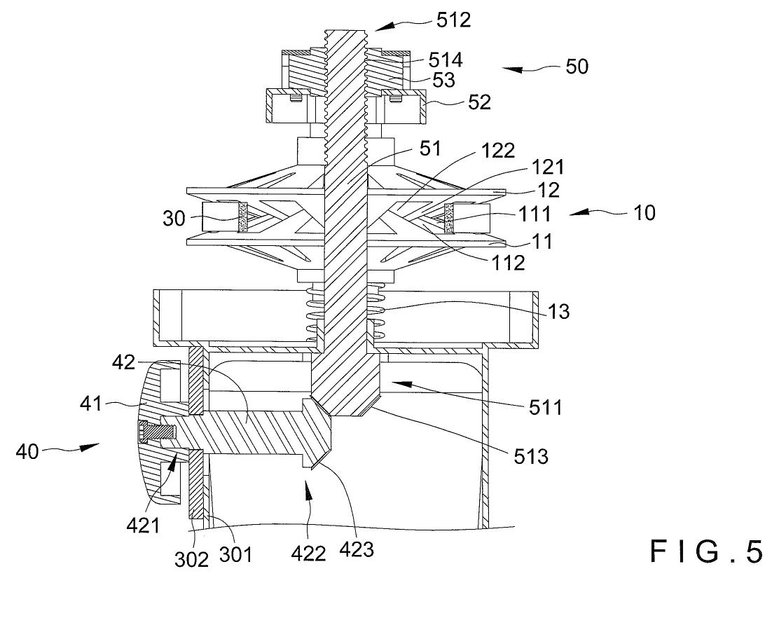

Referring to FIG. 5, the adjustment unit 40 includes a knob 41 provided out of the shell member 3 and an active operating element 42 provided in the shell member 3 and having a first end 421 and a second end 422. A helical gear 423 is formed on the second end 422 of the active operating element 42. A blocked element 302 is coupled to outside of the lateral wall 301 of the shell member 3 of the drill machine and the active operating element 42 would not detach from the blocked element 302. The knob 41 is fixed to the first end 421 of the active operating element 42 and the active operating element 42 is driven to rotate by operating the knob 41. The knob 41 is exposed from the lateral wall 301 of the shell member 3 to provide an easy operation for users.

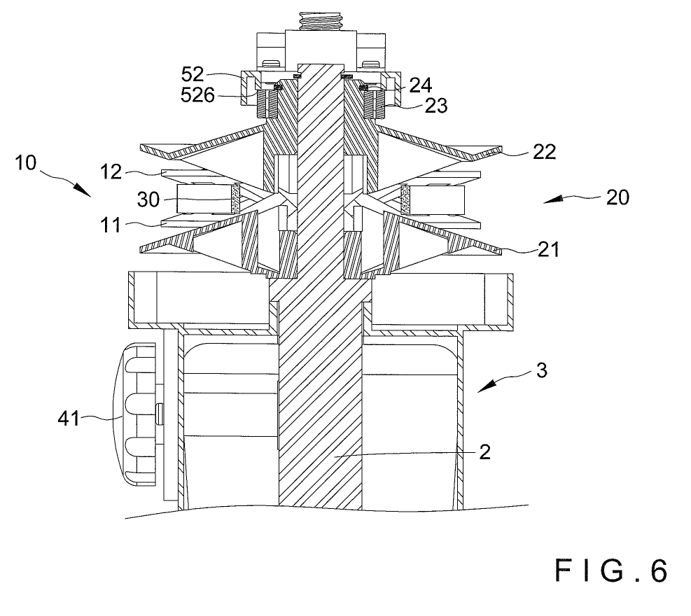

Referring to FIG. 6, the driven operating unit 50 includes a driven element 51 and a pressing element 52. The driven element 51 which has a first end 511 and a second end 512 and is provided between the active disc unit 10 and the driven disc unit 20 and is not coaxial to the spindle 1 of the drill machine. The first end 511 of the driven element 51 is located inside of the shell member 3 of the drill machine. A helical gear 513 is formed on the first end 511 of the driven element 51 and engaged with the helical gear 423. An outer threaded portion 514 is formed on the second end 512 of the driven element 51 and the second end 512 is exposed from a top wall 303 of the shell member 3 of the drill machine.

The pressing element 52 is fixed to the shell member 3 of the drill machine and includes a fulcrum 521, an operating portion 522 and an adjusting portion 523. A rod 524 has a first end fixed to the top wall 303 of the shell member 3 and a second end abutted with the fulcrum 521. A gap 525 is formed on the operating portion 522 opposite to the fulcrum 521. A pressing portion 526 is defined on and protrudes from the periphery of the gap 525. The bearing 23 of the driven disc unit 20 is inserted to the gap 525 and pressed by the pressing portion 526. An inner threaded hole 527 is formed in the adjusting portion 523 as to engage the driven element 51 with the adjusting portion 523. Thus, while the driven element 51 rotates to drive the adjusting portion 523 to move with respect to the driven element 51 and the adjusting portion 523 is restricted in the pressing element 52, the operating portion 522 simultaneously moves with respect to the driven element 51.

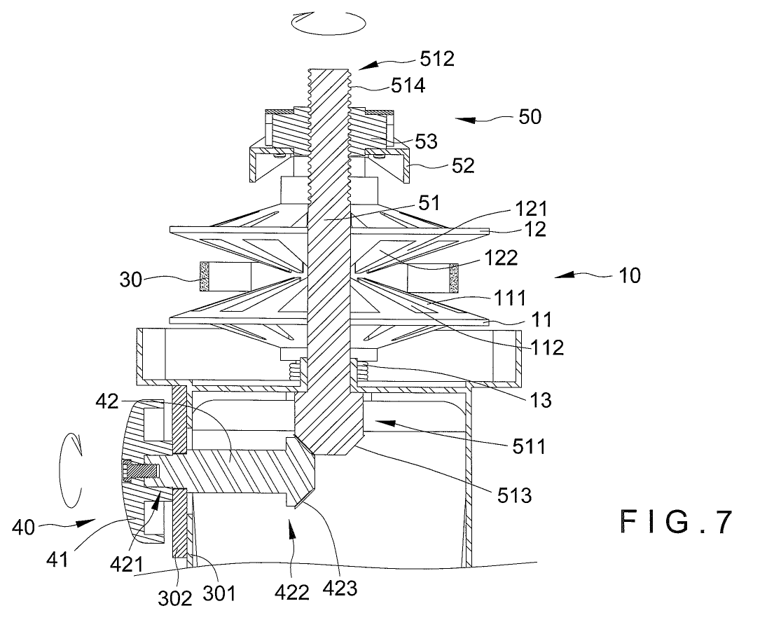

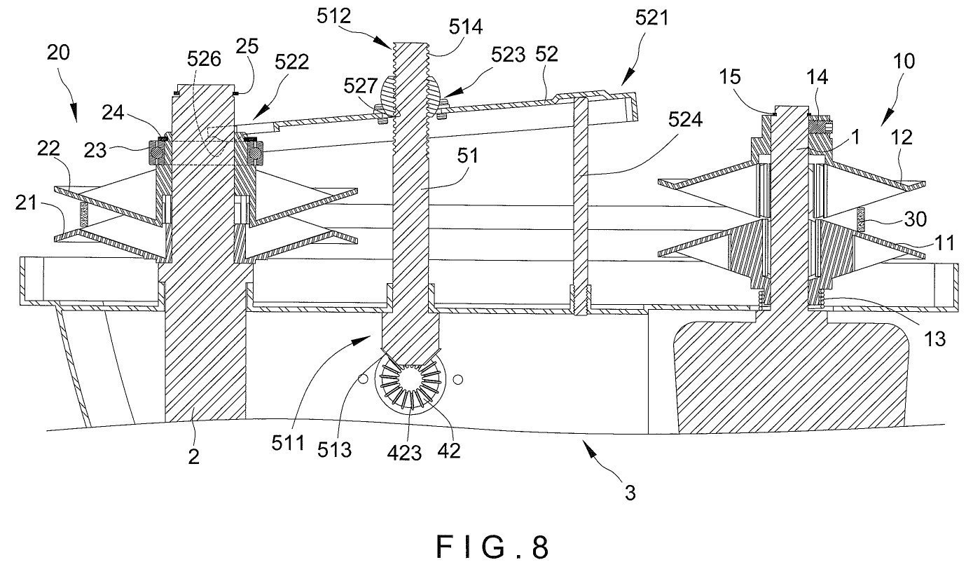

Referring to FIGS. 7 and 8, the adjustment unit 40 is located between the active disc unit 10 and the driven disc unit 20. Users operate the adjustment unit 40 to rotate and drive the driven operating unit 50 and further the first and second wedged discs 11 and 12 are operated to move with respect to each other along the spindle 1 as to control number of rotations of the belt 30 around the wedged discs 11, 12, 21 and 22 via a lever-type adjustment. It provides a time-saving operation and will be described in detail below.

The active operating element 42 is rotated by operating the knob 41 and the helical gear 423 formed on the second end 422 of the active operating element 42 is engaged with the helical gear 513 formed on the first end 511 of the driven element 51 as to drive the driven element 51 to rotate. The outer threaded portion 514 of the driven element 51 is rotated with respect to the inner threaded hole 527 of the adjusting portion 523 to drive the operating portion 522 of the pressing element 52 to move longitudinally along the cutter connective shaft 2. And while the adjusting portion 523 moves toward the second end 512, the pressing portion 526 is driven to move simultaneously. The second wedged disc 22 of the driven disc unit 20 is able to move between the first wedged disc 11 of the active disc unit 10 and the pressing portion 526 and the first wedged disc 11 of the active disc unit 10 is able to move between the second wedged disc 12 of the active disc unit 10 and the drive motor. However, because the elastic element 13 is provided between the shell member 3 and the first wedged disc 11, the first wedged disc 11 has to resist the elastic force of the elastic element 13. And in the other side, the second wedged disc 22 does not have to resist any elastic force so that the second wedged disc 22 would move to the pressing portion 526 directly for making the first and second wedged discs 21 and 22 detaching from each other. The first and second wedged discs 11 and 12 attach to each other via the elastic force of the elastic element 13. The number of rotations of the belt 30 can be adjusted via the attachment/detachment of the first and second wedged discs 11, 12, 21 and 22. Moreover, the height of the active and driven disc units 10 and 20 with respect to the shell member 3 can be adjusted in the meanwhile to achieve an effect of stepless variable speed-change. The driven operating unit 50 is driven to drive the first and second wedged discs 21 and 22 to attach to/detach from each other, and then the belt 30 is driven to operate the first and second wedged discs 11 and 12 to attach to/detach from each other. Hence, the height of a portion of the belt 30 wound on the active disc unit 10 is equal to that of another portion of the belt 30 wound on the driven disc unit. And the belt 30 would not slip on the active and driven disc units 10 and 20 in operation and is not easy to fray or ravel because cooperation of the convex ribs 111, 121 (211, 221) and the concave portions 112, 122 (212, 222) of the first and second wedged discs 11 and 12 (21 and 22).

Moreover, because the driven element 51 of the driven operating unit 50 and the spindle 1 of the drill machine are not coaxial to each other, while the driven element 51 is operated to drive the pressing element 52 to press the active disc unit 10 in a lever manner, a force which the fulcrum 521 provides to the active disc unit 10 would be larger than a force applied by users via the adjustment unit 40. Hence, it provides a time-saving and effort-saving operation.

While several embodiments of the invention have been shown and described, it will be apparent to those skilled in the art that modifications may be made therein without departing from the scope and spirit of the present invention.

What is claimed is:

1. A speed-change device for a drill machine, wherein the drill machine includes a drive motor having a spindle, a cutter connective shaft and a shell member, the device comprising:
an active disc unit installed to the spindle and including a first wedged disc and a second wedged disc paired to the first wedged disc;
a driven disc unit installed to the cutter connective shaft and including a first wedged disc and a second wedged disc paired and coupled to the first wedged disc;
a belt wound around the active disc unit and the driven disc unit, with the active disc unit driving the driven disc unit to operate via the belt; and
an driven operating unit installed to the shell member and including a driven element and a pressing element which is fixed to the shell member and includes a fulcrum, an operating portion and an adjusting portion abutted against the driven disc unit, with the driven element, which is provided on the shell member and not coaxial to the spindle, inserted to the adjusting portion and driving the adjusting portion to move longitudinally with respect to the shell member, with the operating portion moving with respect to the driven element simultaneously, and driving the first and second wedged discs of the driven disc unit to attach to/detach from each other.

2. The speed-change device as claimed in claim 1 wherein a side of the first wedged disc of the active disc unit which faces to a side of the second wedged disc of the active disc unit includes numbers of convex ribs and numbers of concave portions, and numbers of convex ribs and numbers of concave portions are formed on the side of the second wedged disc of the active disc unit and correspond to the numbers of concave portions and numbers of convex ribs in a convex-concave mating manner.

3. The speed-change device as claimed in claim 2 wherein a side of the first wedged disc of the driven disc unit which faces to a side of the second wedged disc of the driven disc unit includes numbers of convex ribs and numbers of concave portions, and numbers of convex ribs and numbers of concave portions are formed on the side of the second wedged disc of the driven disc unit and correspond to the numbers of concave portions and numbers of convex ribs in a convex-concave mating manner.

4. The speed-change device as claimed in claim 1 wherein the driven element is provided between the active and driven disc units.

5. The speed-change device as claimed in claim 3 wherein the driven element has a first end and a second end and is provided between the active disc unit and the driven disc unit, with the first end of the driven element located inside of the shell member of the drill machine.

6. The speed-change device as claimed in claim 5 wherein the adjusting portion of the pressing element has an inner threaded hole and the second end of the driven element forms with an outer threaded portion engaged with the inner threaded hole.

7. The speed-change device as claimed in claim 1 further comprising an elastic element provided between the first wedged disc of the active disc unit and the shell member of the drill machine, with the second wedged disc of the active disc unit fixed to the spindle of the drive motor.

8. The speed-change device as claimed in claim 1 further comprising an adjustment unit engaged with an end of the pressing element opposite to the driven element and including an active operating element driving the driven element to rotate.

9. The speed-change device as claimed in claim 8 wherein the active operating element forms with a helical gear; wherein the driven element has a first end and a second end, with the first end of the driven element forming with a helical gear which is engaged with the helical gear of the operating element.

10. The speed-change device as claimed in claim 2 further comprising a bearing provided to the second wedged disc of the driven disc unit, a gap formed on the operating portion opposite to the fulcrum and a pressing portion defined on and protrudes from the periphery of the gap, with the bearing of the driven disc unit inserted to the gap and pressed by the pressing portion.

11. The speed-change device as claimed in claim 1 further comprising a rod having a first end fixed to a top wall the shell member and a second end abutted with the fulcrum.

12. The speed-change device as claimed in claim 8 further comprising a knob provided out of the shell member, with the active operating element provided inside of the shell member, and with the knob fixed to the active operating element opposite to the driven element of the driven operating unit.
